(19) United States
(12) Patent Application Publication
(10) Pub. No.: US 2018/0152376 A1
(43) Pub. Date: May 31, 2018

(54) Method to Recover Network Controller-to-Router Connectivity using A Low Bandwidth Long-Range Radio Backup Channel

(71) Applicant: John Reumann, Croton on Hudson, NY (US)

(72) Inventor: John Reumann, Croton on Hudson, NY (US)

(21) Appl. No.: 15/361,142

(22) Filed: Nov. 25, 2016

(51) Int. Cl. H04L 12/703; H04L 12/24; H04L 12/939; H04L 12/707

(52) U.S. Cl. CPC H04L 45/28; H04L 45/22; H04L 49/557; H04L 41/0631

(57) ABSTRACT

This present invention describes the use of a uni-directional radio channel to be used for communication from a Controller to a remote Router if the wired Internet connection that connects a Controller to Router becomes unavailable in the direction from the Controller to the Router. The invention provides a slow but widely available uni-directional long-range radio based backup channel that can be used to remotely fix a router misconfiguration that may have caused the disconnection, most likely by switching said router into a safe default mode.

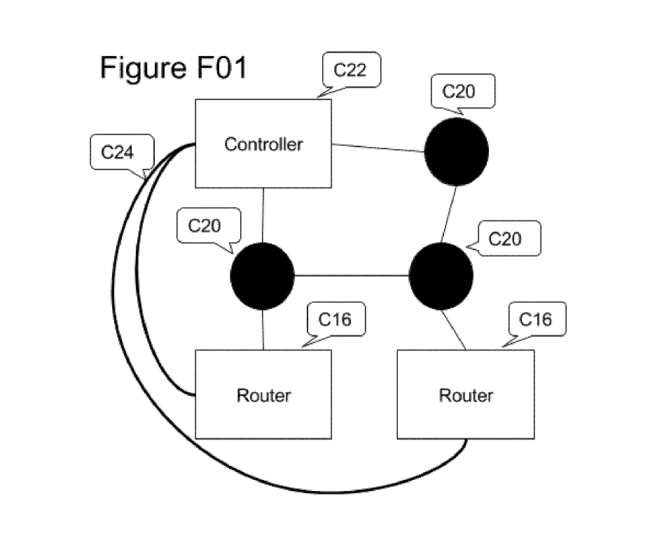

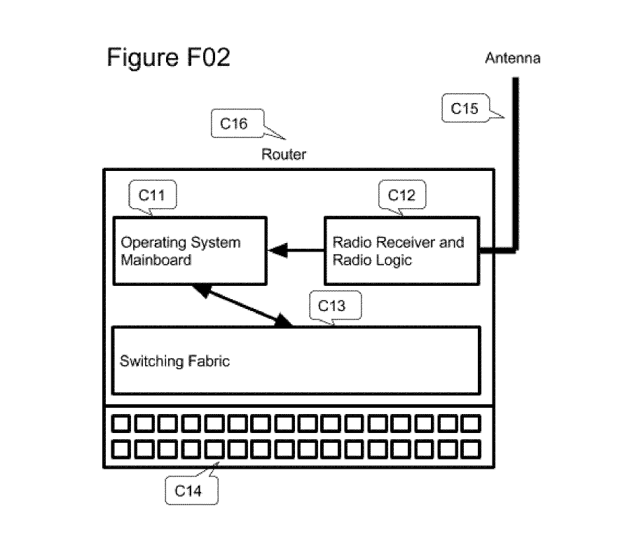

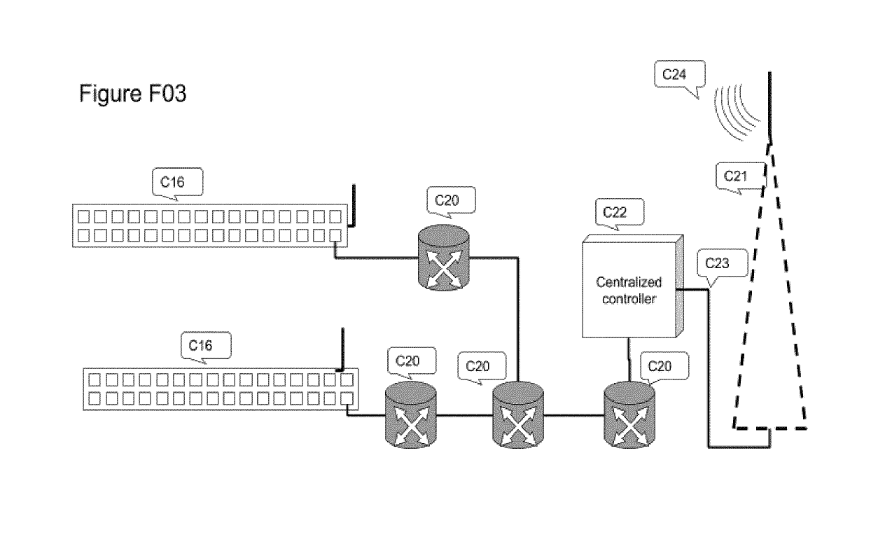

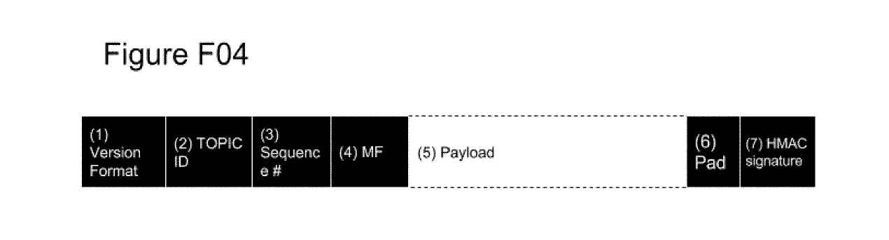

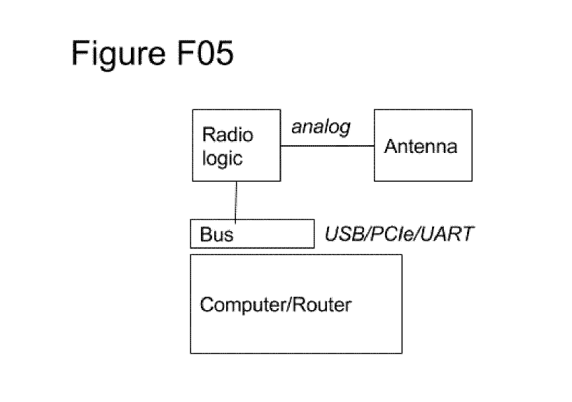

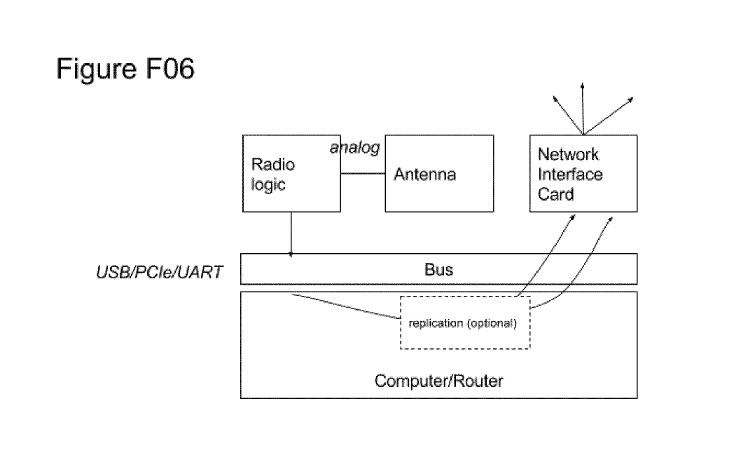

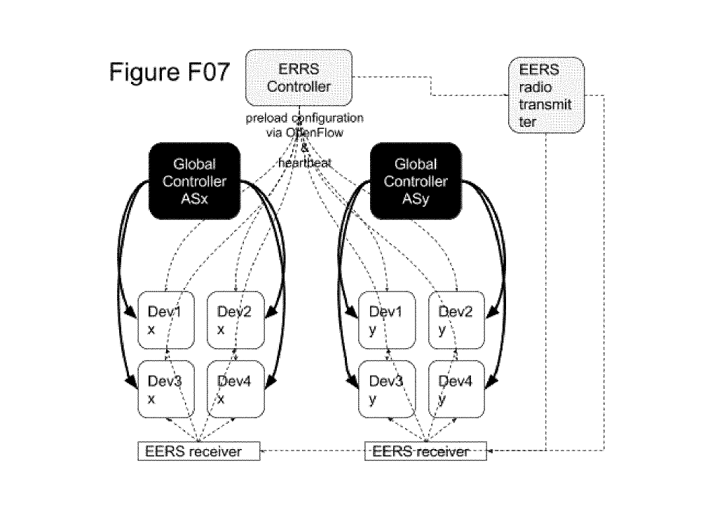

### CROSS-REFERENCE TO RELATED APPLICATIONS

Provisional Private PAIR No. 62/259,819

### TECHNICAL FIELD

This invention relates to the recovery of the communication channel in Computer Network Controller applications in which one or more centralized controller operate on network devices using the Internet Protocol. This field is that of Computer Networks Control Software and Systems.

### BACKGROUND ART

Patent EP0726634B1 (“Funk-Rundsteuerungsempfänger”) specifies a long-range radio transmitter and a hardware receiver device which is capable of receiving signals over long-wave radio which is attached to a computation device such as a microcontroller. This receiver is of value in specific control applications in which a sealed enclosure, a specific device orientation, and includes a specific installation aid. The device is capable of storing decoded messages and the invention describes how those messages can be used to affect control operations, such as light switches, generators and the like. The invention subject of this patent filing assumes the existence and availability of a receiver of the kind described in Patent EP0726634B1. Such receivers are at the time of the filing of this Invention commercially available.

The invention described in Patent EP2253147 (“Method for the unidirectional distribution of information by way of a long-wave radio connection”) describes the dissemination of information (e.g. weather, lottery numbers, . . . ) over long-wave which is encrypted and can only be decrypted by receivers with a shared key. Additionally the key changes based on time, which can be on the same microcontroller since time is sent out unencrypted. The invention also describes a backchannel which could be realized as a mobile phone connection (SMS).

Since in our invention we assume the presence of bi-directional communication in the normal case and low-bandwidth unidirectional communication in emergency scenarios, the key exchanges are realized differently. Our invention assumes a receiver implementing a protocol for selective broadcast as described in EP2253147.

In U.S. Pat. No. 3,848,193 (“Nationwide system for selectively distributing information”) three National warning centers are connected to two high-powered transmitter (on 61.15 kHz), of which two transmitters are configured for failover. The connection between the warning center and the transmitters is wired. The warning sites are connected using wireline. Upon failure of the wireline communication, the warning signal is sent via a backup radio transmitter, instead. The patent that is subject of this patent application also utilizes radio transmission as a backup for wireline failure. However, U.S. Pat. No. 3,848,193 is not applicable to situations in which the failure is induced by problems in a modern data network such as routing configuration, network congestion, it instead presumes a completely isolated control network.

There are further details described in U.S. Pat. No. 3,848,193 that uniquely distinguish it from the invention subject of this patent application. First, all stations in U.S. Pat. No. 3,848,193 are controlled by the same authority while in the present invention the default transmission is over the Internet which has many different authorities and it may even transparently switch between wired and wireless communication. The system of U.S. Pat. No. 3,848,193 is small, while the system subject of this invention is Internet scale and much of its design relates to scale. U.S. Pat. No. 3,848,193 implements simple spoof detection activation, which differs substantially from the modern and secure HMAC approach in the present invention. This design difference is in direct response to the frequency of spoofing attacks in the Internet. The invention disclosed in U.S. Pat. No. 3,848,193 relies on manually entered actions to be taken upon control message receipt at each site, while the present invention describes an automated approach to effecting control.

Patent US20140362790 (“System and Method for Coordinated Remote Control of Network Radio Nodes and Core Network Elements”) describes coordinated remote control of network radio nodes and core network elements. In particular the referenced patent describes how Openflow can be used together with other controllers to configure radio link control layer protocol (RLC) or packet data convergence protocol (PDCP).

The present invention shares the centralized controller approach with patent US20140362790. However, the fails US20140362790 does not apply to the recovery of generic control function during communication link failure and the controlled elements are specifically radio transmitters which require substantially different control messages and methods relative to a network router.

Radio transmission of control information a service (“Tonfrequenz Rundsteuerung”) EFR GmbH offers a commercial service that controls power switches over long-wave radio. The typical use case is to control smart grid generation or production or public lightning. A command is sent to a set of receivers which are most times implemented in hardware or small embedded systems. Typically the only policy sent is either power on or off (on/off) or change of the schedule over the next hours. Customers can purchase control bandwidth from this provider. The present invention does not make claims with regard to a radio service to transmit small control messages to geographically distributed receivers, the specialized method of using such a service for the purpose of transmitting uni-directional control messages to Internet Routers is a unique feature of the present invention. This system only resells radio bandwidth.

The distinguishing features of the present invention include: (i) compressing complex policies into small messages, (ii) using a pre-shared action catalog to effect control actions by merely transmitting a reference id to an action in the pre-shared action catalog, (iii) the integration of Internet communication with the long-wave radio channel.

The patent US20150003259 (“Network system and method of managing topology”) claims the use of Openflow to discover and maintain a view of network topology which is indirectly related to this present invention as both inventions must maintain a view of which links in a computer network are usable and which ones are defective or performing poorly. US20150003259 claims to discover heavy delays of traffic or communication failure on the dataplane in order to update the topology model that is used by the OpenFlow Controller (OFC). This is done by installing a default forwarding rule for injected packets on the dataplane. Should the topology maintenance fail, then the controllers model of the network is updated to exclude the failed link. This is a rephrasing of the spanning tree protocol (STP) lower layer mechanism that is implemented on all network switches. However, the authors turn off layer-2 mode on the switch and install the same rules that STP would have installed automatically, manually by issuing the equivalent OpenFlow instruction.

In patent US20150003259 link failure is detected by regularly transmitting topology discovery packets which require bi-directional link availability. In contrast, the present invention describes a unique method that does not require direct bi-directional, or routable bi-directional communication. The cited patent US20150003259 assumes a working secure channel between controller and controller network device while the present invention addresses the failure of that channel and how to recover connectivity that results from such failure.

Whenever a centralized Controller is used in a network architecture then best practices prescribe that the controller be reachable over a physically separate control network (e.g., a serial console, dedicated network, dialup access) or at the very least that a separate routing be established with QoS (Quality of Service) markings on the traffic that designate “Network Control QoS” which preempts all other communication in the data networks [RFC 2474, RFC 5865].

To the best of our knowledge, low bandwidth long-range radios or unidirectional control are not used to control Routers. However, the method of employing low-bandwidth long-range unidirectional links for control is not novel as the method itself is used in the Electrical Power Grid. Low bandwidth long-range radios are used to control Generators or Loads in the grid to be part in Demand Response programs. The reason why the pre-existing art is not transferable to network control is that the the amount of information needed for recovery of network control is far beyond the capacity of the low-bandwidth channel In the Electrical Grid only single switches need to be toggled in the same manner. In computer networks complex routings have to be re-established the description of which is far too large to be communicated of long-range radio and computer networks have unique challenges such as adversaries, and specialization of messages to the receiving types of Routers.

### SUMMARY OF THE INVENTION

### Technical Problem

This present invention describes how communication between a centralized control processor (C22) (the “Controller”) and a network device (C16) (e.g., a firewall, router, load-balancer, switch, server, or VPN), henceforth, collectively referred as the “Router” can be recovered in case of network failure. This invention enables the use of the network that is being controlled by the Controller for the purpose of control itself without risking loss of control if configuration fails or is disrupted by accidents or malicious attacks. An overview drawing is provided in FIG. F01.

Modern so-called Software-defined-networks (SDN) use data networks extensively to communicate control functions from a Controller to a widely-distributed set of routers. Adoption of this approach has been mixed while large organizations have the capacity to maintain separate data and control planes, smaller organizations cannot afford this and continue on traditional decentralized technology.

### Solution

This present invention describes a method that provides a low-cost alternative recovery method that re-establishes a control plane which runs on the same data network that is being managed by the control plane itself. This is implemented by using a shared, long range radio transmitter to broadcast bootstrap control instructions to Routers that enable those routers to re-establish routing policies in the event that the physical network interconnect between routers cannot be used for reconfiguration.

The present invention utilizes a low-bitrate uni-directional communication channel to send small messages in a secure manner to the Routers who are pre-configured with emergency recovery routines. The messages merely active different recovery routines which then lead to the re-establishment of basic communication on the physical network. Once this step completes, the network can be completely re-configured and managed using standard Software-Defined-Networking approaches (e.g., OpenFlow).

A scenario that highlights the usefulness of this present invention is in the case in which the primary control channel is targeted by a so-called Denial-of-Service (“DoS”) attack. During such an attack one will observe unreliable control communication, potentially disconnecting the Controller from its controlled Routers. Herein is included a detection method that determines whether or not the Routers have been effectively disconnected from their Controller. This invention then continues to specify how the determination of communication failure activates the the long range, low-bitrate transmission of messages that are intended to trigger recovery routines in the Routers. Furthermore, this invention describes the mechanism by which the recovery routines are first distributed to all controlled devices.

Since DoS attacks are frequent source for control plane disruption in the Internet we specifically outline a method that is robust enough to survive a direct attack against the control plane with malicious intent. Some of the aspects of this present invention are designed to address the distinct features of a disruption that is caused by intentional disruption versus a disruption that is merely caused by inadvertent configuration errors.

### Advantageous Effects of the Invention

The present invention allows continued operation of a centralized Controller under a Link overload condition. Such a condition occurs when a single network link is saturated with non-control traffic that is not removed by prioritization of network traffic using methods such as DiffServ. For example, data traffic mis-labeled as network control traffic could cause link overload. In this scenario the root cause of the problem is the mislabeling of control and data traffic, which effectively disconnects the wired control channel.

The controller can repair a traffic control problem in the Router even if the Router was cut off from primary internet communication by misconfiguration. The invention makes such router reachable by the means of a pre-negotiated backup-channel from an Controller device to the the router. This present invention specifically prescribes the uni-directional use of a radio channel to connect to a router. We call this the backup-channel.

Problems that can be overcome include maliciously hijacked routers or DDoS. Failures can be short or long-lasting but in either case the router will be unreachable.

This invention is applicable even if the only means to communicate to the remote server is a uni-directional channel as long as the return path from the Router to the Controller remains functional or an separate backup-channel is established.

This invention is beneficial if Secure Shell or OpenFlow, and other TCP-based configuration protocols are used to reconfigure the Router.

This present invention requires the following hardware components to be installed at the controlled Router in manner displayed in FIG. F02:
C11—Mainboard of the router which includes a operating system
C12—Decoder for long-range radio
C13—Switching fabric, ASIC, FPGA, software router
C14—Patch panel to interconnect the components with computers and other Routers
C15—External antenna to receive long-range radio waves

### DESCRIPTION OF EMBODIMENTS

Definitions of Observed Connectivity Failures

The configuration of the entire system is shown in F03 which comprises several of the Routers of type C16 which are routers that have been modified to be recoverable using the methods of the this present invention, C20 Routers are shown as well. Those C20 routers are Routers that do not require specialized configuration and, therefore, do not require a radio channel for recovery. The configuration remains unchanged even during failures of the data and/or control plane of the network. F03 also displays the Long Range Radio tower C21 whose signal reaches C16 and the centralized controller which communicates to all Routers over the data network during normal operation. The centralized controller uses a backup channel C23 (e.g., SMS, dialup) to reach the radio tower during network failure events to trigger the transmission of recovery messages from C21 to all components labelled C16 over the unidirectional Long Range Radio Channel C24.

The characteristics of a backup channel that is acceptable for network re-pair are as follows:

Ability to reach each individual Router such that the channel's communication path does not physically overlapping with the failed communication path,

there should not be any proximity requirement between the backup control infrastructure and controlled Routers

a backup channel should provide the ability to deliver at least a few bytes per minute of communication bandwidth to each controlled Router at the Controller's discretion.

Example communication channels that could be used as backup channels under with regard to the above requirements are:

long-range radio

satellite communication links

terrestrial broadcast

Low-Power Wide-Area Network

Power-line communications

wireless modems

WiMax.

Limited bandwidth: However, due to the long range of acceptable backup channels each channel covers a very large number of Routers. Consequently there is very little available bandwidth per each Router on these channels. This counteracts some large policy updates, e.g., an Internet routing table is of size greater than 10 MB.

High latency: Due to the long distance the signal must travel, we typically experience high latencies. This could cause typical SDN and Secure Shell Client programs to experience timeouts and disconnects.

Application of the Backup Channel

Control is enacted by a centralized Controller.

By some method, e.g., ping, repeated connection failure, the Controller detects that the router is no longer reachable using the primary Internet connection.

When the controller decides that the target is unreachable, the controller will tunnel it's communication to a routing tunnel C23 from where our system will broadcast this communication using alternate modes of packet encapsulation to the destination server.

Typical methods of encapsulation for C23 from the Controller are GRE, IPSec, IPIP, and other encapsulating methods typically employed in Internet routing. See FIG. F03.

The communication format over the radio channel contains enough information to identify that the message is a emergency control message, it's format version, and security attributes that prevent tampering (HMAC, PAD) and optionally encryption. FIG. F04 shows the backup channel communication message format.

TABLE T01

| Field | Purpose and implementation |
|---|---|
| Version Format (1) | Selection of algorithms and code that is required to make sense of this |
| | message |
| Topic ID (2) | Mechanism to address a subset of receiver Routers. An empty/null topic ID |
| | addresses the entire set of receivers. Routers must be pre-programmed with |
| | topic-ids that identify the types of control messages to which they will |
| | respond. |
| Sequence number (3) | Each message on the topic is numbered in sequential order. |
| FF \| MF (More | Set to MF if the following message on the same channel continues the |
| fragments) (4) | payload of this message. Add FF if this is the first fragment or the only |
| | fragment. |
| Payload (5) | Contains commands or data which can be encrypted |
| Pad (6) | Random bit string to ensure integrity of the hash key. Ignored at sender's |
| | own risk length should not be more than that length of HMAC/signature- |
| | message length without HMAC. |
| Signature or HMAC (7) | A method to ensure integrity of the message and to prevent spoofing |
| | attacks. Our preferred implementation relies only on public-key-derived |
| | HMAC algorithms. |

The HMAC key, as for example, laid out in RFC 2104, is a pre-negotiated key that is associated with the TOPIC ID and installed on every controlled Router. The actual HMAC algorithm in use may vary with the Version number of the message.

Privacy within the message format is optional. Each number and message is visible in the clear. It is obvious that anyone skilled in the art could add privacy but most likely the control messages themselves will already be encrypted.

The underlying transport mechanism will very likely be unable to accommodate typical IP frame sizes, even an IPv6 header may not fit in a single radio message. For example, some vendors for long-range radio bandwidth communication only support messages of length up to 80 bits.

The backup-channel mechanism fragments messages as follows in order to overcome message size limitations imposed by the backup-channel provider.

First, compute the long message as we normally would under the assumption that there is sufficient transport space, i.e., the payload field in T01 will be excessively large.

Second, take the over-sized message of [0005-0009] and break it up into N fragments. Such that each fragment is smaller than the back-channel message size limit. The fragments are still expressed in the form of individual, consecutively broadcast messages of form T01. Fields (1) and (2) of T01 of a oversized message [0005-0009] are copied to all N fragments. Field 3 is set to MF+FF in the first fragment, to MF from the second to N−1-st fragments and to 0 in the N-th fragment. Field (4) of each fragment is the i-th fragment of the original message's payload whose first byte is j+1 byte of the original message the i−1th fragment ended on byte j. Field (5) is unique for each fragment and field (6) is computed on a per fragment basis.

The receive side, must collect all messages of a topic until it sees field 3 without the MF flag, while verifying that there is no break in the sequence numbers received on a topic.

If there is a break in the sequence number a receiver will resume by ignoring all messages received on a topic until it is sees the first fragment which carries the FF flag, at which point it resumes at [0005-0011].

If a complete sequence of fragments is received starting with a FE-labelled fragment and ending with a fragment without the MF flag, then (i) all fragments HMAC's are verified and (ii) the reverse of [0005-0010] is applied to reconstruct the original payload of the oversized message of [0005-0009]. If any fragment's HMAC verification fails, the reconstructed message is dropped. On success, the payload of the reconstructed [0005-0009] message is inserted by into the control path to the Router C20. The packet to the router will be interpreted by the Router's Operating System as if it had been received over the primary control path.

The Router's return or reply path is not prescribed, and may travel over Internet routes because reachability might only be broken in a single direction (e.g., in case of a DDoS).

Physical Attachment of Long Range Receiver to Controlled Router

Single node with antenna and radio.

The single node with an embedded radio and antenna module can be added to any routing device or computer that implements gateway function. This simple configuration is drawn in FIG. F05. It requires a radio receiver adapter to be installed in the Router.

Multi-node receiver with broadcast proxy translating to facility-wide local short range communication:

It is also possible to attach a single receiver device to a large deployment of multiple routers and gateways via a emergency broadcast proxy as shown in FIG. F06. The drawing is an extension of the single antenna module which then relays the broadcast to other receiver stations in the same building, site, or facility using a standard Internet-based broadcast method such as:

Application layer multicast (sending UDP/TCP messages to multiple receivers individually)

IP Multicast (using IP multicast to encapsulate control messages to be broadcast to multiple receivers)

IP Broadcast

Optionally these messages may be tagged with a specific DiffServ marking indicating high priority.

Optionally these messages may be tunneled on their own VLAN. Optionally these messages may be encrypted and authenticated on the local site, building, facility wired network. The key difference to the attachment of [0006-0002] is that the receiver is separated from the router by a network into which the received message [0005-0009] is injected.

Implementation of the invention as a on-demand service:

The mechanisms described so far can be combined into a specific Internet service that is claimed as part of this present invention. The Emergency Router Recovery Service describes a service to which network operators may subscribe in order to aid in the recovery of lost Internet connectivity and to restore control accessibility to their own Routers.

The Emergency Router Recovery Service (ERRS) operates a remote-accessible portal to which network administrators authenticate in typical fashion, e.g., password, certificates, etc. In general, the service will operate remote to the network controlled by the client administrator.

FIG. F07 shows in yellow those components of the system that are provided as a service. It marks in black the SDN Controller of the ERRS customer and in white the Routers that are controlled by their respective AS Controller. The Routers operate within a site, e.g., a POP, IXP, or datacenter. Within each site, the ERRS maintains receiver endpoints that can deliver control signals received from a radio receiver to the individual Routers.

The ERRS presents itself as a VPN router/gateway to customers who want to reach Routers in one or more of the datacenters in which ERRS operates receivers. This is a shared deployment.

This system in its various embodiments is applicable to many industries including the following:

What is claimed is:

1. The method of using a low-bandwidth long-range radio channel to communicate configuration information to a router when said router is unreachable on any of its wired network ports, comprising:
Formatting control messages;
Fragmenting control messages;
Addressing control messages;
Relaying messages from a controller via a transmitter;
Receiving control messages from the controller at a router using a long-range radio adapter;
Changing the configuration of the router.

2. The method of claim 1, wherein only uni-directional communication in the direction from the controller to the router is sent via the long-range radio channel.

3. The method of claim 1, wherein the long-range radio channel is replaced with commercially available cell-phone based data transmission.

4. The method of claim 1, wherein the long-range radio channel is replaced with commercially available carrier SMS text messages.

5. The method of 1, wherein a long-range radio service is used for the transmission of messages.

6. The method of encapsulation and decapsulation of control frames, comprising:
Converting messages into a pre-fragmentation format;
Fragmenting messages to obey payload size limitations that are independent of IP frame sizes;
Fragmenting IP headers;
Consecutively relaying fragments over a public radio channel;
Attaching an HMAC to the end of a sequence of fragment transmissions;
Receiving fragments from a public radio channel;
Verifying the HMAC of received control frames;
Recovering the original control message.

7. The method of claim 6, wherein additional steps are added by a proxy receiver, comprising:
Re-encoding received message in IP protocol;
Re-addressing received message to a router in the data center;
Re-injecting received message into the data center network;
Receiving control message at a router in the data center network.

8. The method of claim 6 using alternate encodings for emergency messages such as: protocol messages, xml, json, fixed width encoding for transmission over the radio channel.

9. The method of using proxies to hide from senders the existence of a backup communication channel to routers; comprising:
Sending each control message to a proxy to reach routers;
Proxies independently forwarding received control messages over wired networking or a uni-directional long-range radio channel to the routers.

10. The method of claim 9, wherein the messages are formatted as IP datagrams.

11. The method of claim 9, wherein a proxy server receives the control messages signal and relays it to routers as in the form of prioritized IP datagrams.
